(19) United States
(12) Patent Application Publication
(10) Pub. No.: US 2026/0367775 A1
(43) Pub. Date: Nov. 19, 2026

(54) CUSTOMIZING DATA ANALYSIS WITH CALCULATOR GRAPHICAL INTERFACES

(71) Applicant: Chime Financial, Inc., San Francisco, CA (US)

(72) Inventors: Yiyang Zeng, Boston, MA (US); Philip Denkabe, Los Altos, CA (US)

(21) Appl. No.: 19/207,003

(22) Filed: May 13, 2025

(51) Int. Cl. G06F 3/04847; G06F 3/0482; G06F 16/25

(52) U.S. Cl. CPC G06F 3/04847; G06F 3/0482; G06F 16/25

(57) ABSTRACT

The present disclosure relates to methods, systems, and non-transitory computer-readable media for generating metrics for data experiments based on a data analysis performed in response to parameters selected on an interactive graphical user interface. Specifically, the disclosed systems can provide selectable experiment parameters for performing a data experiment. Based on the selected experiment parameters, the disclosed systems generate a database management query to retrieve data associated with the selected experiment parameters from historical data. The disclosed systems generate baseline metrics based on the retrieved historical data. Based on the baseline metrics, the disclosed systems calculate a selected target metric for performing the data experiments, generating a graphical user interface for the calculated selected target metric along with selected interactive variables related to the calculated selected target metric. Based on client device interactions with the interactive variables, the disclosed systems automatically update the calculated selected target metric.

### BRIEF DESCRIPTION OF THE DRAWINGS

The detailed description provides one or more embodiments with additional specificity and detail through the use of the accompanying drawings, as briefly described below.

FIG. 1 illustrates an overview of utilizing a data experiment configuration system to generate data analysis results according to baseline metrics generated from selected parameters in accordance with one or more embodiments.

FIG. 2 illustrates an example graphical user interface for selecting parameters to generate baseline metrics in accordance with one or more embodiments.

FIG. 3 illustrates an example graphical user interface for generating and editing a database management query in accordance with one or more embodiments.

FIG. 4 illustrates an example diagram of utilizing a database management query to generate baseline metrics in accordance with one or more embodiments.

FIGS. 5A-5C illustrate example graphical user interfaces for interacting with and modifying data analysis results generated from baseline metrics in accordance with one or more embodiments.

FIG. 6 illustrates a diagram of an environment in which a data experiment configuration system can operate in accordance with one or more embodiments.

FIG. 7 illustrates an example flowchart of a series of acts for generating data analysis results based on selectable experiment parameters and generated baseline metrics in accordance with one or more embodiments.

FIG. 8 illustrates a block diagram of an exemplary computing device in accordance with one or more embodiments.

FIG. 9 illustrates an example environment for an inter-network facilitation system in accordance with one or more embodiments.

### DETAILED DESCRIPTION

This disclosure describes one or more embodiments of a data experiment configuration system that configures data experiments via a graphical user interface for customizing experimental parameters and target metrics to generate and present interactable data analysis results with corresponding baseline metrics. Specifically, in one or more embodiments, the data experiment configuration system presents selectable options for a client device to select experiment parameters and generate baseline metrics for the data experiment. Further, in response to selected options and experiment parameters, the data experiment configuration system generates an interactable database management query for display on a graphical user interface, which the data experiment configuration system utilizes to query a database to generate the baseline metrics. Additionally, the data experiment configuration system provides an additional graphical user interface for utilizing the baseline metrics to generate data analysis results for a selected target metric (i.e., lift, power, or sample size) and displaying the data analysis results. In particular, the data experiment configuration system can iteratively update the data analysis results based on client device interactions with the graphical user interface and according to the generated baseline metrics.

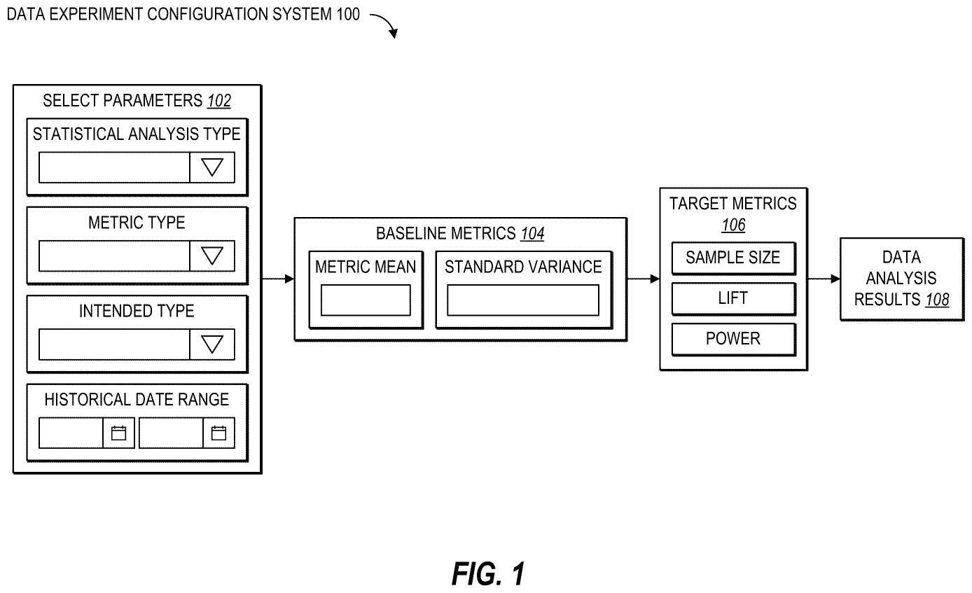

Turning now to the figures, FIG. 1 illustrates an overview of generating and presenting data analysis results based on selected parameters and baseline metrics, in accordance with one or more embodiments. Additional detail regarding the various acts and processes introduced in relation to FIG. 1 is provided thereafter with reference to subsequent figures.

As illustrated in FIG. 1, the data experiment configuration system 100 provides selectable parameters 102. In particular, the data experiment configuration system 100 provides the selectable parameters 102 to a graphical user interface (“GUI”) for selection by a client device. In one or more embodiments, the data experiment configuration system 100 provides the selectable parameters 102 as options for designing and executing parameters for a data analysis. For example, the data experiment configuration system 100 displays an interactive graphical user interface for a client device to select experiment parameters such as a statistical analysis type parameter, a metric type parameter, an intended population parameter, and a historical date range parameter.

As further illustrated in FIG. 1, the data experiment configuration system 100 utilizes the parameters selected from the selectable parameters 102 to generate baseline metrics 104. In particular, the data experiment configuration system 100 generates the baseline metrics 104 by generating a database management query using the selectable parameters 102. In one or more embodiments, the data experiment configuration system 100 executes the database management query by communicating with a database to determine the baseline metrics 104 from the selectable parameters 102 and historical data identified via the selected parameters. Additionally, in one or more embodiments, the data experiment configuration system 100 presents the database management query for display within a GUI for client device interaction and editing with the code of the database management query. In one or more embodiments, the data experiment configuration system 100 generates the baseline metrics 104 as certain foundational statistical metrics (e.g., a metric mean value and a standard deviation value) used to build the data experiment and to automatically populate/select certain values in subsequent interfaces and operations of the data experiment.

As further illustrated in FIG. 1, the data experiment configuration system 100 provides target metrics 106 for selection within a GUI in response to generating the baseline metrics 104. In particular, the data experiment configuration system 100 generates the target metrics 106 as selectable options (e.g., power, lift, sample size) within a calculator-based GUI for directing a data experiment. In one or more embodiments, the data experiment configuration system 100 presents the target metrics 106 with selectable variables for calculating and/or updating a data experiment for the target metrics 106 based on updating the selectable variables. In one or more embodiments, the data experiment configuration system 100 provides the target metrics 106 as interdependent metrics with automatically populating fields in the graphical user interface, such that alterations made to the selectable variables of a selected target metric updates the variables and values of the other target metrics available for selection within a display. In one or more embodiments, the data experiment configuration system 100 provides tools within the GUI for a client device to update or edit the baseline metrics 104 or the database management query associated with the selectable parameters 102.

As further illustrated in FIG. 1, the data experiment configuration system 100 generates data analysis results 108 based on the target metrics 106 and the baseline metrics. In particular, the data experiment configuration system 100 presents the data analysis results 108 on the GUI in response to user interactions to initiate the data experiment using the entered variables and values. In one or more embodiments, the data experiment configuration system 100 provides, via the GUI, the ability for a client device to copy and share the data of the data analysis results 108 across devices, computing applications, or other digital communication method. In one or more embodiments, the data experiment configuration system 100 presents the data analysis results 108 so that, in response to a client device interaction with the GUI, the data experiment configuration system 100 toggles between multiple target metrics with separate customizable variable fields for the data analysis results 108. In one or more embodiments, the data experiment configuration system 100 includes within the data analysis results 108 a duration that the data analysis would take to perform.

In certain embodiments, the data experiment configuration system 100 generates the data analysis results 108 according to a proportion metric type of experimentation metric (e.g., indicating the proportion of members of the dataset performing certain behaviors). In one or more embodiments, the data experiment configuration system 100 generates the data analysis results 108 according to a continuous metric type of experimentation metric (e.g., indicating the average amount of certain behaviors performed by members of the dataset). In additional embodiments, the data experiment configuration system 100 generates the data analysis results 108 according to a ratio metric type of experimentation metric (e.g., generating a ratio of two metrics at a unit for the dataset), utilizing one or more ratio metric methodologies (e.g., the power analysis method of Delta Method). In additional embodiments, the data experiment configuration system 100 utilizes differentiated statistical tests for different scenarios, including a Z test for proportional metrics, a T test for continuous metrics, and the Delta Method for ratio metrics. In one or more embodiments, the data experiment configuration system 100 automatically applies the experimentation metric type best fitting the data analysis.

Due to the increased capabilities of computing systems to perform complex analysis on different types of data and on large quantities of data, some conventional systems provide computer programming tools for setting up and executing statistical analyses or other data experiments on certain data types. These conventional systems, however, typically provide limited options for a client device to interact with a dataset and construct statistical analyses. As an example, conventional systems provide options for a client device to enter parameters for executing data experiments for finding/calculating a particular metric. Because of the limitations of these conventional systems, the conventional systems exhibit a number of deficiencies or drawbacks, particularly relating to functionality and flexibility.

For instance, as noted above, conventional systems are often limited to presenting a limited set of statistical analyses and a limited set of experimental parameters. As an example, conventional systems typically require users to have substantial understanding of various computer programming languages and statistical concepts to ensure that the computing systems perform the analyses with the correct code and statistical functions. Additionally, due to the limited tools of the conventional systems, the conventional systems also typically require users to have a detailed understanding of digital data sources for finding and accessing specific datasets.

Furthermore, conventional systems often give rise to errors resulting from inconsistencies between scripts or other computer code involved in executing data analyses. For instance, conventional systems that rely on different users, computing systems, and/or computing applications to perform data analyses often introduce errors in communications between devices or incorrect retrieval of data during the data analyses due to differences in computer programming languages of different computer applications or computing devices, code generated by users, and/or incorrect retrieval of information. Thus, due to programming inconsistencies or incompatibilities, computing devices or software applications of conventional systems can produce errors in data analyses without providing tools for easily correcting such errors.

In one or more embodiments, the data experiment configuration system 100 provides several improvements or advantages relative to existing system. For instance, the data experiment configuration system 100 improves functionality and flexibility over prior systems. In particular, in contrast to conventional systems, the data experiment configuration system 100 provides graphical user interface tools for generating and establishing a variety of experiment parameters for generating various baseline metrics for a data experiment, such as analysis type parameter, population type parameter (including one or more population subsets), a metric type parameter, and a historical data range parameter. Further, the data experiment configuration system 100 leverages database interaction tools (e.g., automated database management query generation and database access operations) to generate the initial baseline metrics based on the experimental parameters and to generate target metrics with the initial baseline metrics, improving the functionality of the system by providing both baseline metrics and target metrics via a progressive set of GUIs and database interactions.

Further, the data experiment configuration system 100 improves flexibility in one or more embodiments. For example, in contrast to conventional systems, the data experiment configuration system 100 flexibly updates various GUIs to display multiple target metrics (e.g., lift, power, and sample size) and corresponding variables in response to a client device interaction selecting one of the target metrics without requiring a separate data experiment. Further, the data experiment configuration system 100 updates the target metrics based on adjustments to one or more selected variables, dynamically altering the data experiment in real time based on client device interactions with the selected variables through the GUI.

As mentioned, the data experiment configuration system 100 also provides improved accuracy of computing systems executing data experiments via automated queries in connection with the progressive GUIs. For instance, the data experiment configuration system 100 uses selected/indicated experiment parameters to automatically generate a database management query in a database query language with corresponding calls to access specific portions of data in one or more databases to generate baseline metrics. Furthermore, the data experiment configuration system 100 ensures accuracy by surfacing the generated query in a user interface to allow for verification and/or editing of the query prior to executing the query. In some cases, the data experiment configuration system 100 also executes the database management query to access the corresponding dataset(s) and generate the baseline metrics for subsequent operations in the data experiment (e.g., for use in calculating target values).

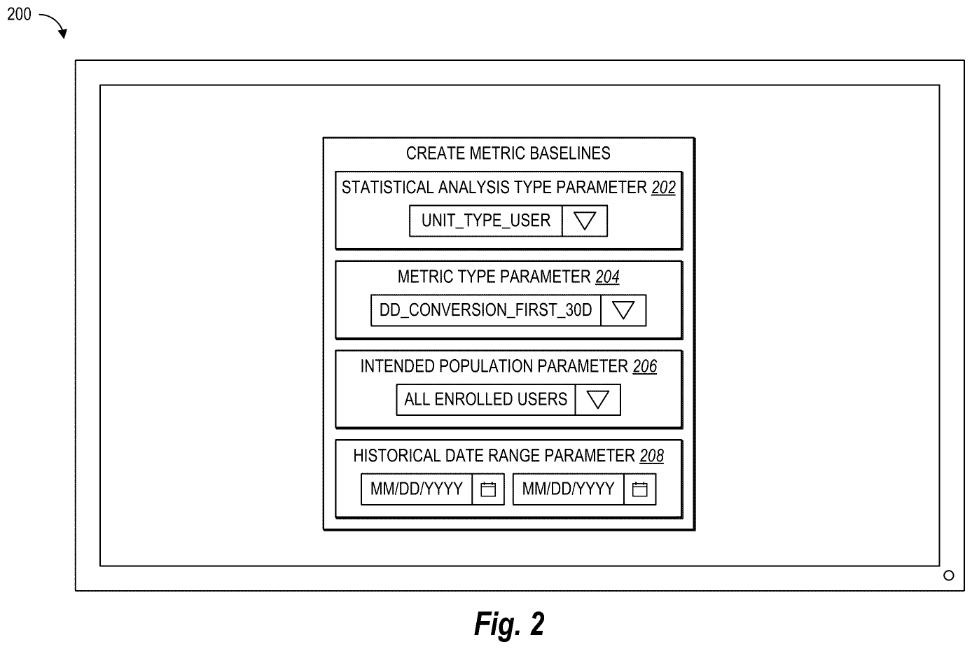

As mentioned above, the data experiment configuration system 100 can provide an interactive GUI with a set of selectable experiment parameters for performing a data experiment, including pre-processing operations involving accessing and analyzing a specific dataset to generate baseline metrics for the data experiment. FIG. 2 illustrates an example diagram of determining and presenting experiment parameters for selection on a GUI for performing a data experiment in accordance with one or more embodiments.

As illustrated in FIG. 2, the data experiment configuration system 100 presents the experiment parameters on a GUI 200. In particular, the data experiment configuration system 100 provides the GUI 200 to a client device for selection and display. In one or more embodiments, the data experiment configuration system 100 dynamically updates the GUI 200 upon the client device selecting one or more experiment parameters selected on the GUI 200.

As used herein, the term experiment parameters refers to one or more editable parameters (e.g., statistical analysis type parameter 202, metric type parameter 204, intended population parameter 206, and/or historical date range parameter 208) guiding the execution of a data experiment. In particular, an experiment parameter guides the execution of the data experiment and is selectable by a client device via the GUI. For example, an experiment parameter defines aspects of a data experiment such as the statistical analysis type, a metric for the data experiment to use, an intended population for the data experiment, and a historical date range for the data experiment for accessing a database and generating baseline metrics. In one or more embodiments, the data experiment configuration system 100 uses the selected experiment parameters to determine which dataset to access on one or more databases for processing. Furthermore, in some embodiments, the data experiment configuration system 100 determines the experiment parameters available for selection based on attributes of datasets in the one or more databases.

As further illustrated in FIG. 2, the data experiment configuration system 100 presents a statistical analysis type parameter 202 for selection via the GUI 200. In particular, the data experiment configuration system 100 presents the statistical analysis type parameter 202 for selecting the unit type analyzed as part of the data experiment. In one or more embodiments, the data experiment configuration system 100 presents the statistical analysis type parameter 202 as a drop-down menu in which the client device can select the specific data unit type (e.g., users of a certain application, subscribers to a particular service, anonymized unit types) analyzed by the data experiment configuration system 100 for the data experiment. In one or more embodiments, the data experiment configuration system 100 presents the statistical analysis type parameter 202 as a text box for entering parameters for a data experiment. Additionally, in some embodiments, the data experiment configuration system 100 provides autocompletion of entered parameters by accessing a set of valid parameters (e.g., linked to existing datasets in a database) and matching entered text with one or more of the valid parameters.

As used herein, the statistical analysis type parameter 202 refers to a parameter defining a unit type of data analyzed or generated during a data experiment. In particular, a statistical analysis type parameter 202 defines a database that the statistical analysis will pull from, or the dataset utilized for the statistical analysis, according to the unit type. For example, the data experiment configuration system 100 determines the statistical analysis type parameter 202 by defining whether the data analysis is performed on a dataset corresponding to a certain environment (e.g., members/users of a certain app, program, or platform) or anonymized to the environment.

As further illustrated in FIG. 2, the data experiment configuration system 100 presents a metric type parameter 204 for selection on the GUI 200. In particular, the data experiment configuration system 100 presents the metric type parameter 204 for selecting a specific metric analyzed by the data experiment (e.g., the primary metric that the data experiment should move). To illustrate, the metric type parameter 204 includes, but is not limited to, metrics such as numbers of trial users converted into subscribed users, provisional credits converted into actual credits, or subscribed users retained). In one or more embodiments, the data experiment configuration system 100, in response to a client device selection of the metric type parameter 204, automatically imports existing metrics corresponding to the client device selection of the metric type parameter 204. In one or more embodiments, the data experiment configuration system 100 presents an interactive GUI element (e.g., a drop-down menu with a predefined list and/or a text box) for selecting the metric type parameter 204. Further, in one or more embodiments, the data experiment configuration system 100 allows a client device to enter a custom metric type parameter not included within a predefined list as the metric type parameter 204.

As used herein, the metric type parameter 204 refers to a parameter defining a key indicator or similar metric to be modified/moved during a data experiment according to a population or a dataset. For example, the data experiment configuration system 100 selects the metric type parameter 204 from a predefined set of key indicators (e.g., conversion from a provisional user into a user, use rate, retention rate as noted above) associated with a population or a dataset.

As further illustrated in FIG. 2, the data experiment configuration system 100 presents an intended population parameter 206 for selection on the GUI 200. In particular, the data experiment configuration system 100 presents the intended population parameter 206 within the GUI as a selectable drop-down menu. In one or more embodiments, the data experiment configuration system 100 presents the intended population parameter 206 as a text box into which a client device can input an intended population. In one or more embodiments, the data experiment configuration system 100 configures the intended population parameter 206 for selecting a specific population (e.g., all enrolled users, all trial users) or target segment within the statistical analysis type parameter 202 for the data experiment. Further, in one or more embodiments, the data experiment configuration system 100 presents the intended population parameter 206 for the client device to select a population subset or cohort within a larger population. In one or more embodiments, the data experiment configuration system 100 infers suitable population segments for the intended population parameter 206 based on the client device selection of the statistical analysis type parameter 202. To illustrate, the data experiment configuration system 100 determines one or more segments that are only relevant to specific populations (e.g., existing users vs. prospect customers).

As further illustrated in FIG. 2, the data experiment configuration system 100 presents a historical date range parameter 208 for selection on the GUI 200. In particular, the data experiment configuration system 100 presents the historical date range parameter 208 as a selectable beginning date and end date for data points for the data experiment. Specifically, the data experiment configuration system 100 uses the historical date range parameter 208 to select a specific dataset corresponding to the other selected parameters for the data experiment by limiting the data used for the data experiment to the indicated range of dates. In one or more embodiments, the data experiment configuration system 100 presents the historical date range parameter 208 as selectable calendars (e.g., generating a pop-up window within the GUI 200 with a calendar view).

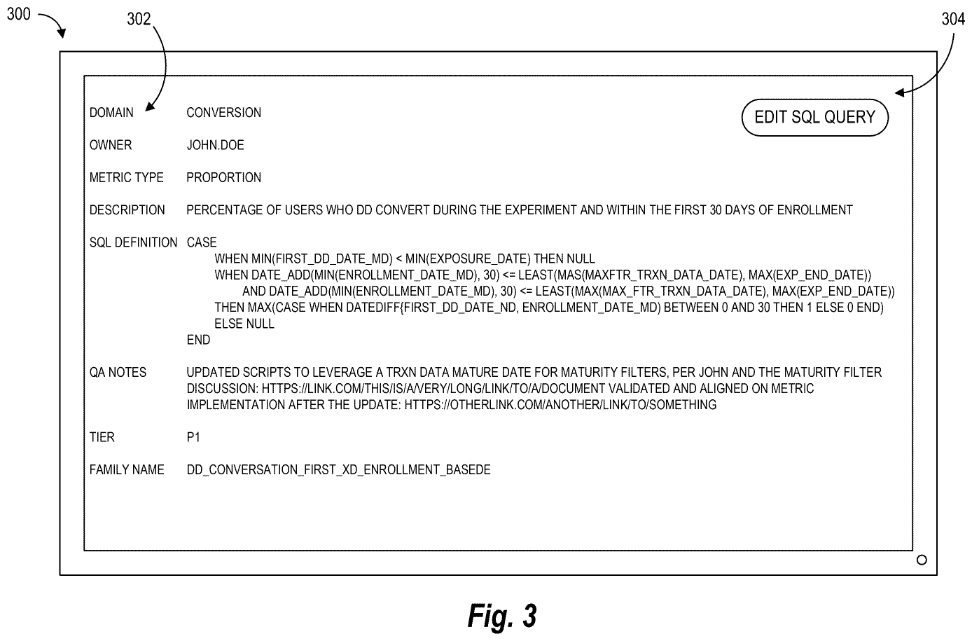

As mentioned above, the data experiment configuration system 100 can generate a database management query and display the generated database management query on a GUI. FIG. 3 illustrates an example GUI of generating and displaying a database management query in accordance with one or more embodiments.

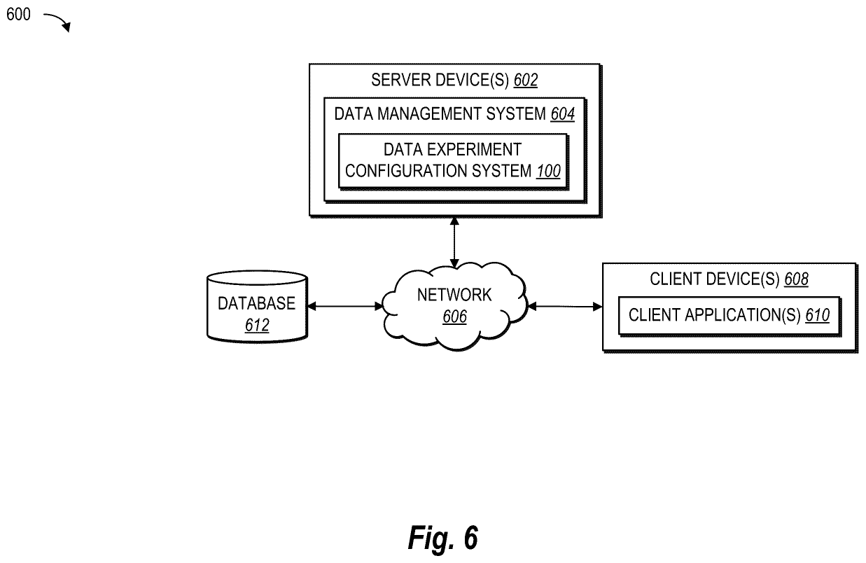

As illustrated in FIG. 3, the data experiment configuration system 100 generates a database management query 302 and displays the database management query 302 on a GUI 300. In particular, the data experiment configuration system 100 generates the database management query 302 based on the experiment parameters selected by the client device (e.g., the selectable parameters described in relation to FIG. 2) in response to a selection of an option to generate metric baselines utilizing the selected parameters. In one or more embodiments, the data experiment configuration system 100 generates the database management query 302 to retrieve and process data from a database (e.g., the database 612 of FIG. 6) corresponding to the experiment parameters selected by the client device.

As used herein, the database management query 302 is a request for information sent to a database system. In particular, the data experiment configuration system 100 generates the database management query 302 to interact with and extract information from one or more databases for the data experiment. For example, the data experiment configuration system 100 generates the database management query 302 in a domain-specific language corresponding to a database (e.g., Structured Query Language (“SQL”)). In one or more embodiments, the data experiment configuration system 100 utilizes the database management query 302 to retrieve information in a specified dataset (e.g., data corresponding to one or more experiment parameters such as population data for the indicated date range) from the database. To illustrate, the data experiment configuration system 100 can detect a selection of an option to generate baseline metrics for a data experiment according to a set of selected parameters and automatically generate and execute the database management query 302 in response to the selection of the option. Thus, in response to a selection of an option via the GUI 300, the data experiment configuration system 100 generates a query including specific database access code, executes the code to retrieve a specified dataset from a database, and analyzes the dataset to generate the baseline metrics. Alternatively, the data experiment configuration system 100 can generate the database management query 302 in response to a selection of one or more of the parameters via the GUI 300.

As further illustrated in FIG. 3, the data experiment configuration system 100 presents an editing interactable element 304 within the GUI 300 for viewing and editing the database management query 302 generated in response to generating the database management query 302 (e.g., in response to a selection to create the baseline metrics). In particular, by interacting with the editing interactable element 304, the data experiment configuration system 100 generates a user interface display within the GUI 300 in which the database management query 302 can be verified or edited at a text level. For example, in response to a client device selection of a custom metric type parameter (e.g., an action to enter a custom metric type parameter within the metric type parameter 204), the data experiment configuration system 100 presents the editing interactable element 304 for the client device to further update and customize the database management query 302 according to the custom metric type parameter. In one or more embodiments, the data experiment configuration system 100, in response to an interaction with the editing interactable element 304, generates a pop-up window (or other interface) for altering or editing the database management query 302. For example, the data experiment configuration system 100 can provide tools for viewing, deleting, or editing the database management query 302 within the pop-up window, including text editing tools, code verification tools (e.g., for the corresponding database query language), or other tools for modifying and executing (or re-executing) the database management query 302 on the database. Furthermore, in one or more embodiments, the data experiment configuration system 100 also provides additional details associated with the database management query 302 including, but not limited to, selected parameters, notes on the data experiment, ownership of the data experiment, or other details.

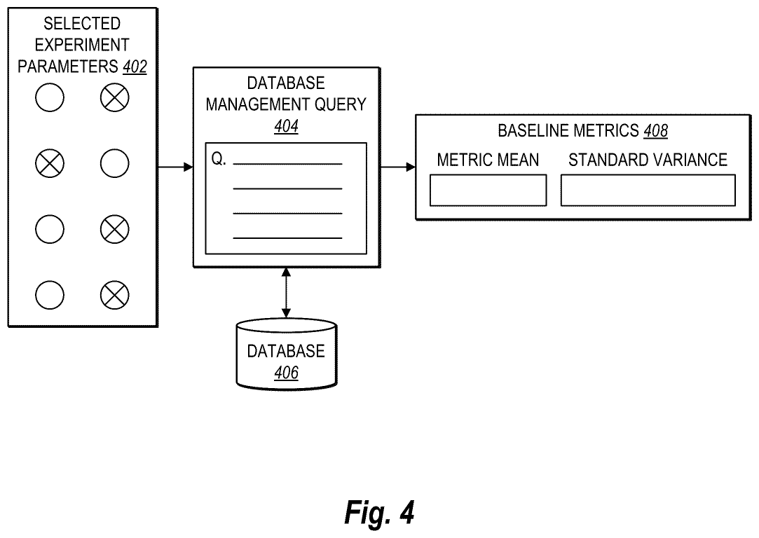

As mentioned, in one or more embodiments, the data experiment configuration system 100 utilizes a database management query generated based on selected experiment parameters to generate baseline metrics for a data experiment. FIG. 4 illustrates an example diagram of the data experiment configuration system 100 utilizing a database management query to generate baseline metrics from data within a database in accordance with one or more embodiments.

As illustrated in FIG. 4, the data experiment configuration system 100 generates a database management query 404 based on the selected experiment parameters 402. In particular, the data experiment configuration system 100 generates the database management query 404 as a computer language (e.g., SQL) instruction to retrieve data related to the selected experiment parameters 402.

As further illustrated in FIG. 4, the data experiment configuration system 100 utilizes the database management query 404 to retrieve data from a database 406. In particular, the data experiment configuration system 100 leverages the database management query 404 to retrieve data corresponding to experiment parameters such as the experiment type, the population, the metric type, and the historical date range. In one or more additional embodiments, the data experiment configuration system 100 retrieves data according to more or fewer parameters than those described above in relation to FIG. 3 according to the particular data experiment and the data available in the database 406. In one or more embodiments, the data experiment configuration system 100 accesses the database 406 to obtain data related to a certain entity, application, or platform. In certain embodiments, the data experiment configuration system 100 accesses the database 406 to retrieve data from a publicly available dataset.

As further illustrated in FIG. 4, the data experiment configuration system 100 generates baseline metrics 408 based on the database management query 404 and the data sourced from the database 406. In particular, the data experiment configuration system 100 generates the baseline metrics 408 to set baseline standards for the data experiment (e.g., by fixing one or more variables for performing the data experiment). In one or more embodiments, the data experiment configuration system 100 generates the baseline metrics 408 including a metric mean and a standard variance by analyzing the data indicated according to the selected parameters. In one or more embodiments, the data experiment configuration system 100 generates the baseline metrics 408 to include a set of metrics including means, variance, standard deviations, and/or other metrics for constraining one or more results of the data experiment.

As used herein, the baseline metrics 408 refer to specific metrics fundamental to performing statistical analyses in a data experiment. In particular, the baseline metrics 408 refer to a metric determined based on the selected experiment parameters as an intermediate step or preliminary step to generating a target metric. For example, the data experiment configuration system 100 generates a metric mean value and/or a standard deviation based on the selected experiment parameters, which the data experiment configuration system 100 utilizes to generate a target metric. In some embodiments, the baseline metrics 408 include a metric generated utilizing historical data relevant to a data experiment. To illustrate, the selected parameters indicating the particular dataset for generating the baseline metrics 408 can include parameters defining a dataset with similar characteristics to data in the data experiment (e.g., for a similar unit type, metric type, population, date range). In one or more embodiments, the data experiment configuration system 100 generates the baseline metrics according to preexisting metric definitions (e.g., definitions corresponding with a specific statistical analysis platform).

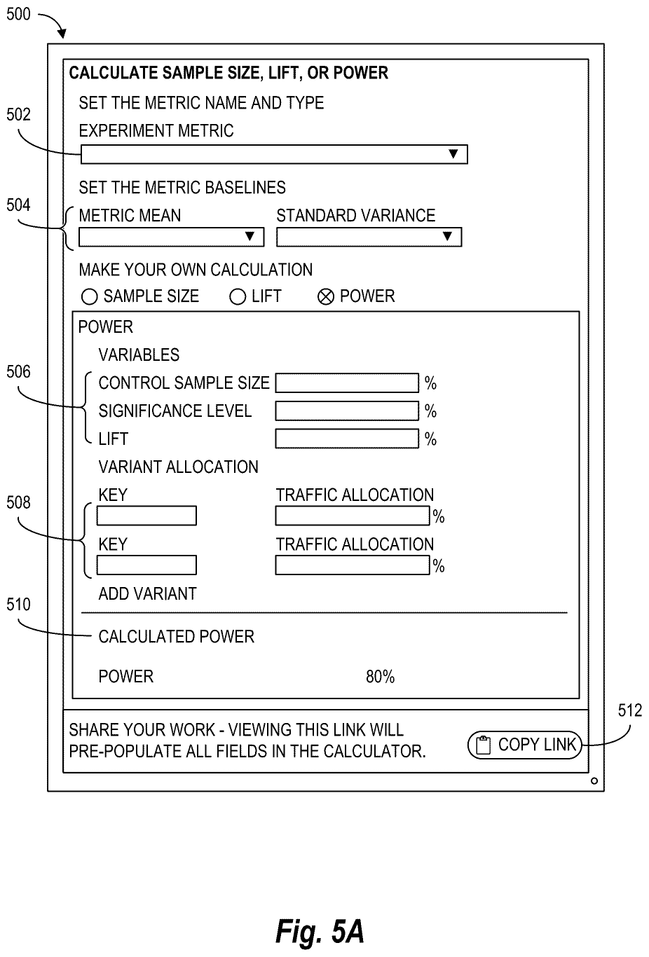

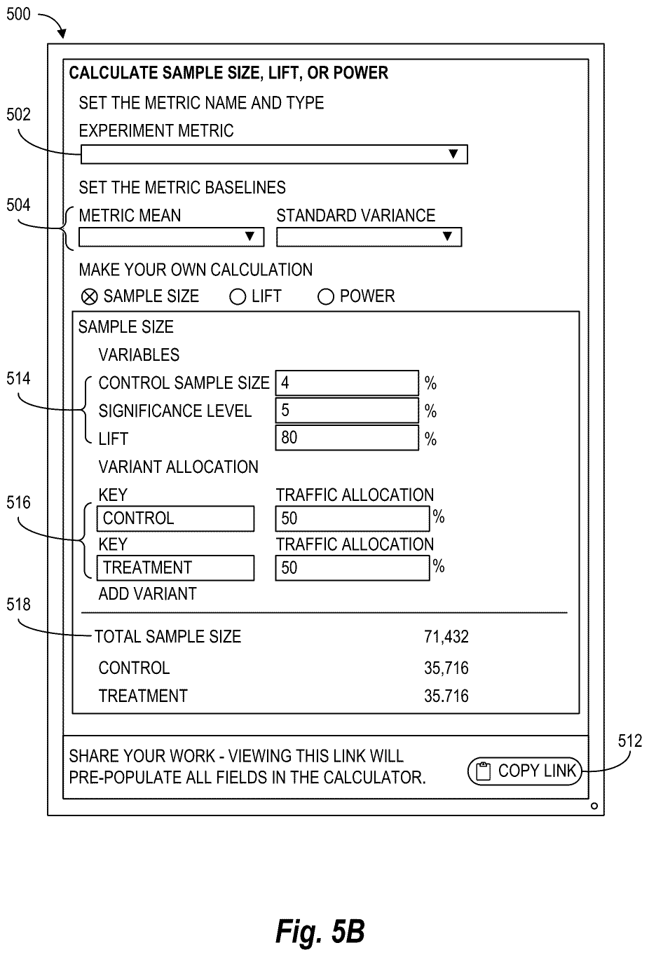

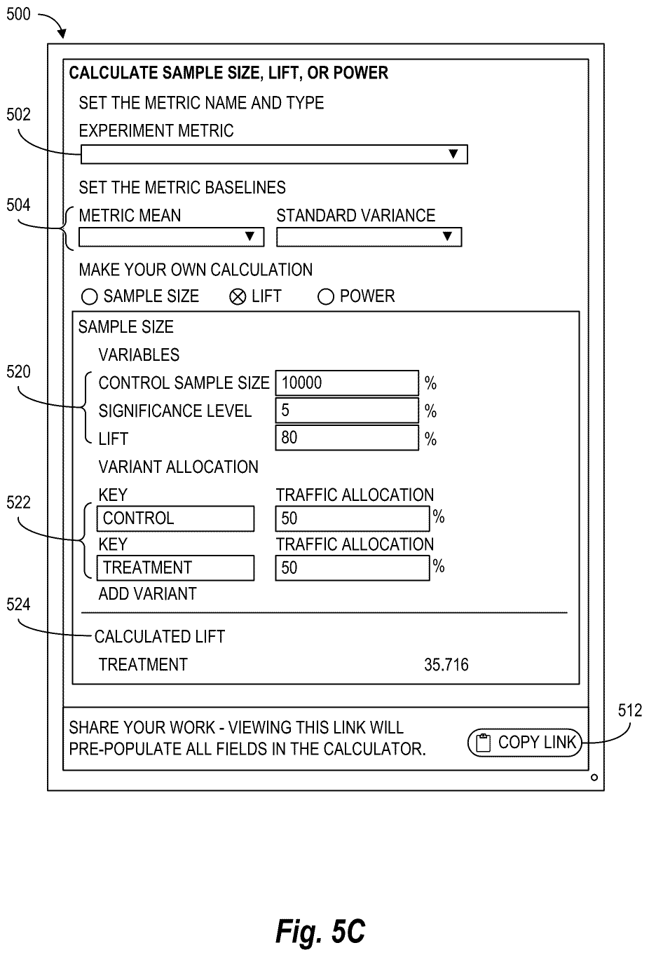

As mentioned, the data experiment configuration system 100 can generate target metrics and present target metrics for display on a GUI. FIGS. 5A-5C illustrate example GUIs for generating and displaying interactable target metrics and selected variables in accordance with one or more embodiments. FIG. 5A illustrates a sample interactive GUI for displaying the target metric of power as well as other selected variables in accordance with one or more embodiments. FIG. 5B illustrates a sample interactive GUI for displaying the target metric of sample size as well as other selected variables in accordance with one or more embodiments. FIG. 5C illustrates a sample interactive GUI for displaying the target metric of lift as well as other selected variables in accordance with one or more embodiments.

As illustrated in FIG. 5A, the data experiment configuration system 100 generates a target metric display for display on a GUI 500. In particular, the data experiment configuration system 100 generates the target metric display to display a calculated target metric 510 (e.g., sample size, lift, or power) along with selectable variables 506 (e.g., significance level, sample size, lift, or power depending on the selected target metric). In one or more embodiments, the data experiment configuration system 100 utilizes the target metric display to present selectable options for a client device to edit or alter the relevant variables to update the selected target metric on the GUI 500. In one or more embodiments, the data experiment configuration system 100 provides a textual explanation detailing how the calculated target metric 510 is calculated for display within the GUI 500. For instance, the data experiment configuration system 100 provides the textual explanation in response to a selection of a particular target metric and/or in connection with displaying the available selectable metrics in response to generating baseline metrics.

As further illustrated in FIG. 5A, the data experiment configuration system 100 presents an experiment metric 502 and baseline metrics 504 via the GUI 500. In particular, the data experiment configuration system 100 presents the experiment metric 502 to refer to a parameter defining a key indicator or similar metric modified or moved during the data experiment according to a population or dataset (e.g., the metric type parameter 204 of FIG. 2). In one or more embodiments, the data experiment configuration system 100 presents the baseline metrics 504 (e.g., the baseline metrics 408 of FIG. 4) in accordance with executing a database management query utilizing selected experiment parameters. In one or more embodiments, the data experiment configuration system 100 automatically populates the baseline metrics 504 with metrics generated by executing the database management query (e.g., the database management query 404 of FIG. 4) on data from a database (e.g., the database 406 of FIG. 4). In one or more embodiments, the data experiment configuration system 100 presents the baseline metrics 504 as editable fields (e.g., editable text boxes) updatable in response to client device interactions.

As further illustrated in FIG. 5A, the data experiment configuration system 100 presents selectable variables 506 based on the selected target metric. In particular, the data experiment configuration system 100 presents the selectable variables 506 for alteration and update by a client device via the GUI 500. In certain embodiments, in response to a selection via the client device of the calculated target metric 510 as “Power,” the data experiment configuration system 100 presents the selectable variables 506 as “Control Sample Size,” “Significance Level,” and “Lift.” In one or more embodiments, the data experiment configuration system 100, based on receiving a client device interaction with the selectable variables 506 (e.g., entering an alternative control sample size), updates the calculated target metric 510 (updating the value of power). In one or more embodiments, the data experiment configuration system 100 automatically populates the selectable variables 506 in response to a client device selection.

As further illustrated in FIG. 5A, the data experiment configuration system 100 presents selectable variant allocation 508 for presentation on the GUI 500. In particular, the data experiment configuration system 100 presents the selectable variant allocation 508 to introduce variability into the data experiment by adding subgroups to the data experiment. In one or more embodiments, the data experiment configuration system 100 generates the selectable variant allocation 508 so that the client device can specify the proportion that each variant makes up of the overall data experiment (e.g., allocating 50% of the data experiment to a control group and allocating 50% of the data experiment to a treatment group). In one or more embodiments, the data experiment configuration system 100 provides an option to add another variant within the selectable variant allocation 508, permitting the client device to add as many variants as needed for the data experiment. In one or more embodiments, the data experiment configuration system 100 calculates target metrics (e.g., the calculated target metric 510) automatically and intelligently for multi-variant scenarios.

As further illustrated in FIG. 5A, the data experiment configuration system 100 provides a calculated target metric 510 for presentation on the GUI 500. In particular, the data experiment configuration system 100 generates the calculated target metric 510 based on generated baseline metrics (e.g., the baseline metrics 408 of FIG. 4) and values automatically populated within the selectable variables 506 and the selectable variant allocation 508. In one or more embodiments, the data experiment configuration system 100 iteratively updates the calculated target metric 510 based on client device interactions (e.g., altering a number within a text box) with the selectable variables 506 and the selectable variant allocation 508. For example, if the client device updates a value within the selectable variables 506 (e.g., altering the value of the significance level), the data experiment configuration system 100 updates the value of the calculated target metric 510 displayed on the GUI 500 (e.g., by altering the value of the “power” target metric). In one or more embodiments, the data experiment configuration system 100 presents the calculated target metric 510 and the selectable variables 506 as interdependent metrics, automatically populating fields in the GUI 500.

As used herein, the calculated target metric 510 refers to one or more metrics generated as a product of a data experiment. In particular, the calculated target metric 510 includes metrics used to structure and guide future statistical analyses set up by the data experiment. For example, the data experiment configuration system 100 generates several target metrics including sample size, lift, and power based on the selected experiment parameters and the associated metric baselines.

As used herein, sample size refers to the minimum number of users required to satisfy target lift and power metrics. For example, the data experiment configuration system 100 calculates sample size based on lift and power to determine a minimum number of samples (e.g., a minimum value of the intended population parameter 206 of FIG. 2) needed to meet lift and power thresholds. Further, although larger values of the sample size metric lead to generally more meaningful statistical analysis results, calculating a minimally required sample size improves computer processing and efficiency. Thus, in one or more embodiments, the data experiment configuration system 100 targets the minimally required sample sizes automatically.

As used herein, lift refers to the percentage change in key metrics (e.g., the metric selected with the metric type parameter 204 of FIG. 2) for each variant compared to a control value. For example, lift determines how well the data experiment performed by the data experiment configuration system 100 performs relative to the control value.

As used herein, power refers to a measure of the ability of each variable (e.g., the selectable variables 506) to affect the key metric (e.g., the metric type parameter 204). For example, a higher power indicates that the variable has a higher likelihood of impact on the key metric (e.g., a higher confidence).

As further illustrated in FIG. 5A, the data experiment configuration system 100 provides a selectable copy element 512 for display within the GUI 500. In particular, the data experiment configuration system 100 provides the selectable copy element 512 so that a client device can automatically copy a version of the target metric display with the same values filled within the selectable variables 506, the selectable variant allocation 508, and the calculated target metric 510. In one or more embodiments, the data experiment configuration system 100, in response to a client device interaction with the selectable copy element 512, generates a copyable hyperlink that the client device can share with another client device. In one or more embodiments, the data experiment configuration system 100, in response to a client device interaction with a selectable copy element 512, generates a temporary version of the target metric display for streaming on a second client device. Thus, the data experiment configuration system 100 provides a shareable link to ensure consistency and accuracy of data experiment parameters and results across multiple computing devices.

As illustrated in FIG. 5B, the data experiment configuration system 100 updates the GUI 500 based on a client device selection of a different target metric. In particular, based on a client device selection of the target metric of sample size, the data experiment configuration system 100 updates the GUI 500 to display the calculated target metric 518 of sample size along with corresponding selectable variables 514 correlating with sample size. For example, the selectable variables 514 for the sample size target metric include fields for lift and power. In one or more embodiments, the data experiment configuration system 100 automatically generates the calculated target metric 518 displaying sample size based on the baseline metrics (e.g., the baseline metrics 408 of FIG. 4) upon the client device selecting the target metric of sample size within the GUI 500. In one or more embodiments, the data experiment configuration system 100 automatically updates the calculated target metric 518 displaying sample size upon the client device altering the values of the corresponding selectable variables 514 or the selectable variant allocation 516.

As illustrated in FIG. 5C, the data experiment configuration system 100 updates the GUI 500 based on a client device selection of a different target metric within the GUI 500. In particular, based on a client device selection of the target metric of lift, the data experiment configuration system 100 automatically updates the GUI 500 to display the calculated target metric 524 of lift along with corresponding selectable variables 520 correlating with generating a lift value. For instance, the selectable variables 520 for the lift target metric include fields for sample size and power. In one or more embodiments, the data experiment configuration system 100, in response to a client device updating the selectable variables 520 correlating with generating a lift provalue along with the selectable variant allocation 522, automatically updates the calculated target metric 524. In one or more embodiments, the data experiment configuration system 100, in response to generating the calculated target metric 524 of lift, generates an additional value for how long a data experiment needs to run on available samples to generate the calculated target metric 524 of lift by analyzing how long it would take to recruit the minimally required sample size for the data experiment.

In some embodiments, the data experiment configuration system 100 is part of a networking environment. For example, FIG. 6 illustrates a diagram of an example environment in which the data experiment configuration system 100 can operate in accordance with one or more embodiments.

As shown in FIG. 6, system 600 includes server device(s) 602 (which includes inter-network facilitation system 604 and data experiment configuration system 100), client device(s) 608, and database 612. As further illustrated in FIG. 6, the server device(s) 602, the client device(s) 608, and the database 612 can communicate via the network 606.

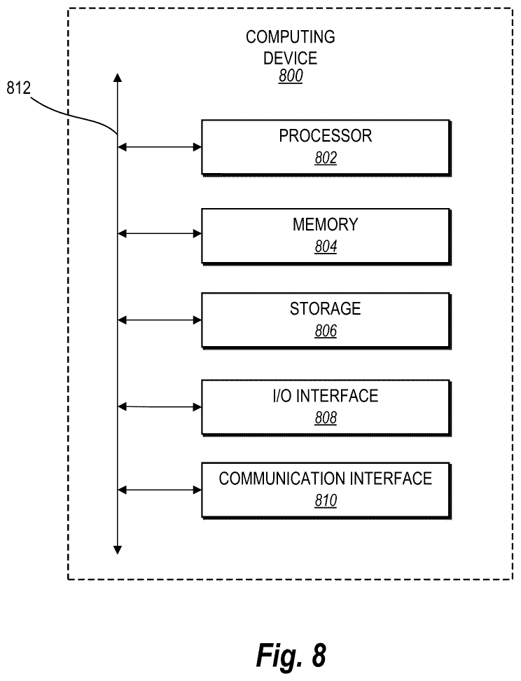

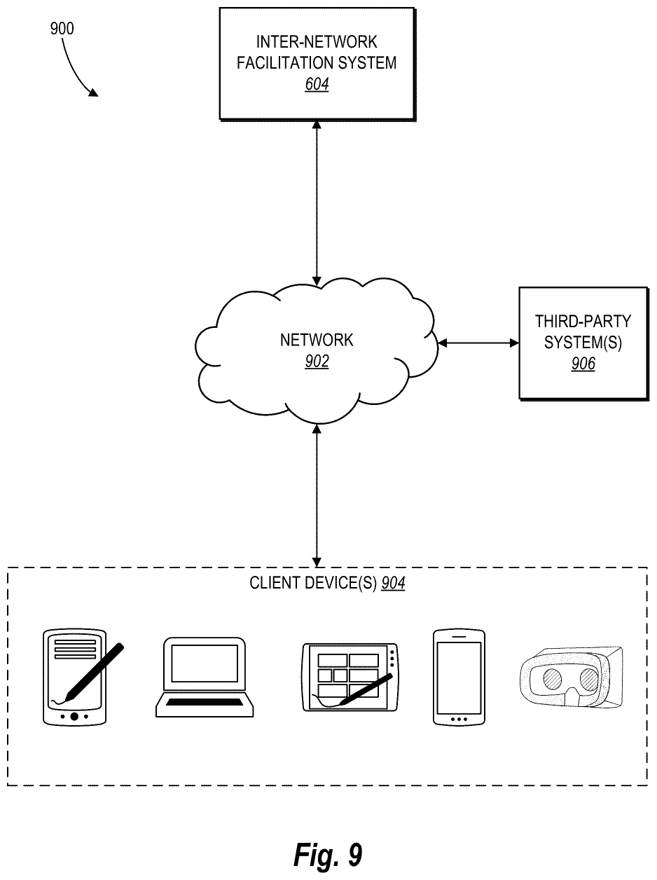

Although FIG. 6 illustrates the data experiment configuration system 100 being implemented by a particular component and/or device within system 600, the data experiment configuration system 100 can be implemented, in whole or in part, by other computing devices and/or components within the system 600 (e.g., the client device(s) 608). Additional description regarding the illustrated computing devices (e.g., the server device(s) 602, computing devices implementing the data experiment configuration system 100, the client device(s) 608, the database 612, and/or the network 606) is provided with respect to FIGS. 8-9 below.

As shown in FIG. 6, the server device(s) 602 can include the inter-network facilitation system 604. In some embodiments, the inter-network facilitation system 604 can determine, store, generate, and/or display data relating to a data experiment (e.g., population information, conversion information, date range values). Furthermore, the inter-network facilitation system 604 can also electronically communicate with database storing the data relating to a data experiment (e.g., the database 612). Moreover, the inter-network facilitation system 604 can also track and/or monitor data experiments configured within the GUI presented by the data experiment configuration system 100.

The inter-network facilitation system 604 can include a system that comprises the data experiment configuration system 100 and that facilitates generating and preparing data experiments across one or more networks. For example, the inter-network facilitation system 604 manages and compiles data (e.g., population information, conversion information, date range values) stored across a variety of locations within the inter-network facilitation system 604. In some cases, the inter-network facilitation system 604 is a centralized network system that facilitates access to stored data within a central network location. Indeed, the inter-network facilitation system 604 can link data from a plurality of databases (e.g., the database 612), both stored within proprietary servers and stored as publicly available information.

As also illustrated in FIG. 6, system 600 includes the client device(s) 608. For example, the client device(s) 608 may include, but are not limited to, mobile devices (e.g., smartphones, tablets) or other types of computing devices, including those explained below with reference to FIGS. 8-9. Additionally, the client device(s) 608 can include computing devices associated with databases for the inter-network facilitation system 604. Moreover system 600 can include various numbers of client devices that communicate and/or interact with the inter-network facilitation system 604 and/or the data experiment configuration system 100.

Furthermore, as shown in FIG. 6, the client device(s) 608 can include client application(s) 610. Client application(s) 610 can include instructions that (upon execution) cause the client device(s) 608 to perform various actions. For example, a user can interact with client application(s) 610 on client device(s) 608 to design, alter, or share data experiments based on data sourced from the database 612. Furthermore, in one or more implementations, the client application(s) 610 can display one or more graphical user interfaces from which the data experiment configuration system 100 can receive and display information regarding data experiments.

In certain instances, the client device(s) 608 corresponds to one or more user accounts (e.g., user accounts stored at the server device(s) 602). For instance, a user of a client device can establish a user account with login credentials and various information corresponding to the user. In addition, the user accounts can include a variety of information regarding saved data values and/or saved data experiments. In some embodiments, a user account can be accessed via multiple devices (e.g., multiple client devices) when authorized and authenticated to access the user account within the multiple devices.

The present disclosure utilizes client devices to refer to devices associated with such user accounts. In referring to a client (or user) device, the disclosure and the claims are not limited to communications with a specific device but any device corresponding to a user account of a particular user. Accordingly, in using the term client device, this disclosure can refer to any computing device corresponding to a user account of the inter-network facilitation system 604.

As illustrated in FIG. 6, system 600 includes a database 612. In one or more embodiments, the database 612 stores data accessed to perform a data experiment (e.g., by a database management query as illustrated in FIG. 4). In one or more embodiments, the database 612 stores information associated with a proprietary dataset (e.g., information associated with users of a certain application). In one or more embodiments, the database 612 stores information publicly available (e.g., publicly available datasets). In one or more embodiments, the other components of the system 600 interact with the information stored within the database 612 by generating and sending a database management query (e.g., the database management query 404 of FIG. 4) to retrieve information from the database 612. As illustrated, the database 612 can be located on a separate server. In some cases, the database 612 can be integrated or included in the data experiment configuration system 100 or the inter-network facilitation system 604.

As further shown in FIG. 6, the system 600 includes the network 606. As mentioned above, the network 606 can enable communication between components of the system 600. In one or more embodiments, the network 606 may include a suitable network and may communicate using a various number of communication platforms and technologies suitable for transmitting data and/or communication signals, examples of which are described with reference to FIG. 8. Furthermore, although FIG. 6 illustrates the server device(s) 602, the client device(s) 608, and the database 612 communicating via the network 606, the various components of the system 600 can communicate and/or interact via other methods (e.g., the server device(s) 602 and the client device(s) 608 can communicate directly).

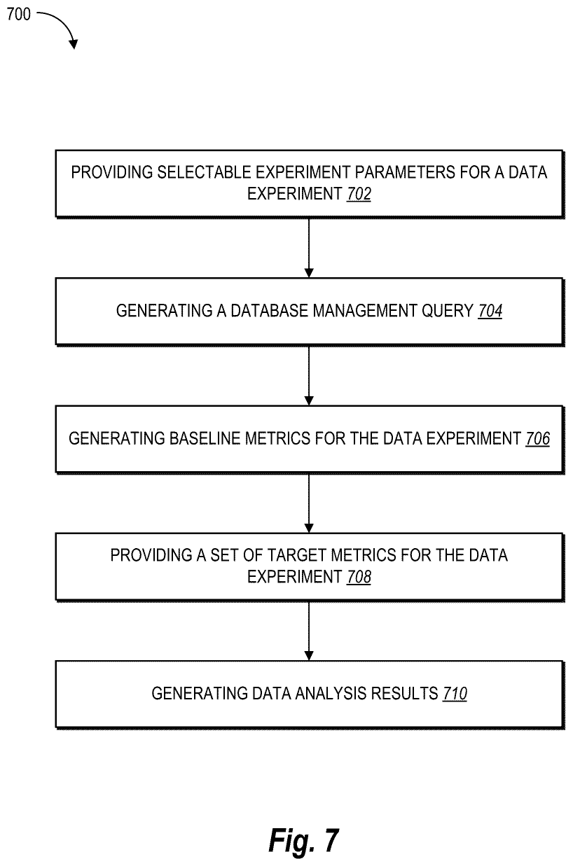

FIGS. 1-6, the corresponding text, and the examples provide a number of different systems and methods for generating and testing data experiments. In addition to the foregoing, implementations can also be described in terms of flowcharts comprising acts as steps in a method for accomplishing a particular result. For example, FIG. 7 illustrates an example flowchart of a series of acts for generating data analysis results in accordance with one or more embodiments. While FIG. 7 illustrates acts according to certain implementations, alternative implementations may omit, add to, reorder, and/or modify any of the acts shown in FIG. 7. The acts of FIG. 7 can be performed as part of a method. Alternatively, a non-transitory computer readable medium can comprise instructions that, when executed by one or more processor, cause a computing device to perform the acts of FIG. 7. In still further implementations, a system can perform the acts of FIG. 7. Additionally, the acts described herein may be repeated or performed in parallel with one another or in parallel with different instances of the same or other similar acts.

As illustrated in FIG. 7, the series of acts 700 may include an act 702 of providing selectable experiment parameters for a data experiment. In particular the act 702 involves providing, by at least one processor and for display on a graphical user interface, selectable options comprising a plurality of experiment parameters for performing a data experiment. The series of acts 700 can also include an act 704 of generating a database management query. In particular, the act 704 can include generating, by the at least one processor in response to a set of selected options form the selectable options, a database management query comprising selected experiment parameters from a plurality of experiment metrics and a plurality of segments. The series of acts 700 can also include an act 706 of generating baseline metrics for the data experiment. In particular, the act 706 includes generating, by the at least one processor, baseline metrics defining statistical values for the data experiment by executing the database management query on a historical dataset stored at a database according to the selected experiment parameters. The series of acts 700 can also include an act 708 of providing a set of target metrics for the data experiment. In particular, the act 708 includes providing, by the at least one processor and for display within the graphical user interface, a set of target metrics for performing the data experiment utilizing a set of variables and the baseline metrics. The series of acts 700 can also include an act 710 of generating data analysis results. In particular, the act 710 includes generating, by the at least one processor and for display within a calculator interface, data analysis results comprising a calculated value for a selected target metric of the set of target metrics by executing the data experiment utilizing the baseline metrics and selected variables from the set of variables.

In some embodiments, the series of acts 700 includes an act of determining, in response to one or more interactions with the selectable options in the graphical user interface, the plurality of experiment parameters comprising one or more of: a statistical analysis type parameter from a predefined list of statistical analysis types; a metric type parameter from a predefined list of metric types; an intended population parameter from a predefined list of intended populations; or a historical date range parameter from a set of historical date ranges of historical data in the database.

In some embodiments, the series of acts 700 includes an act of determining, in response to an interaction with a selectable option of the selectable options, the intended population parameter comprising a population type parameter or a population subset parameter. The series of acts 700 can also include generating, based on the selected experiment parameters and the historical dataset, a metric mean value and a standard deviation value for the data experiment.

In some embodiments, the series of acts 700 includes an act of presenting, for display within the graphical user interface, the baseline metrics in one or more editable fields by auto-populating the one or more editable fields in response to generating the baseline metrics. The series of acts 700 can also include determining the selected target metric in response to an interaction with the set of target metrics via the graphical user interface. The series of acts 700 can also include providing, for display within the graphical user interface, a plurality of editable fields comprising the set of variables according to the selected target metric. The series of acts 700 can also include providing, for display within the graphical user interface, an updated calculated value for the selected target metric in response to an interaction with an editable field of the plurality of editable fields modifying a variable of the set of variables.

In some embodiments, the series of acts 700 includes an act of concurrently generating corresponding calculated values for the set of target metrics by executing the data experiment utilizing the baseline metrics and selected variables from the set of variables.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 8 illustrates a block diagram of an example computing device 800 that may be configured to perform one or more of the processes described above. One will appreciate that one or more computing devices, such as the computing device 800 may represent the computing devices described above (e.g., computing device 800, server device(s) 602, client device(s) 608). In one or more embodiments, the computing device 800 may be a mobile device (e.g., a mobile telephone, a smartphone, a PDA, a tablet, a laptop, a camera, a tracker, a watch, a wearable device, etc.). In some embodiments, the computing device 800 may be a non-mobile device (e.g., a desktop computer or another type of client device). Further, the computing device 800 may be a server device that includes cloud-based processing and storage capabilities.

As shown in FIG. 9, the computing device 800 can include one or more processor(s) 802, memory 804, a storage device 806, input/output interfaces 808 (or “I/O interfaces 808”), and a communication interface 810, which may be communicatively coupled by way of a communication infrastructure (e.g., bus 812). While the computing device 800 is shown in FIG. 8, the components illustrated in FIG. 8 are not intended to be limiting. Additional or alternative components may be used in other embodiments. Furthermore, in certain embodiments, the computing device 800 includes fewer components than those shown in FIG. 8. Components of the computing device 800 shown in FIG. 8 will now be described in additional detail.

In particular embodiments, the processor(s) 802 includes hardware for executing instructions, such as those making up a computer program. As an example, and not by way of limitation, to execute instructions, the processor(s) 802 may retrieve (or fetch) the instructions from an internal register, an internal cache, memory 804, or a storage device 806 and decode and execute them.

The computing device 800 includes memory 804, which is coupled to the processor(s) 802. The memory 804 may be used for storing data, metadata, and programs for execution by the processor(s). The memory 804 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 804 may be internal or distributed memory.

The computing device 800 includes a storage device 806 includes storage for storing data or instructions. As an example, and not by way of limitation, the storage device 806 can include a non-transitory storage medium described above. The storage device 806 may include a hard disk drive (HDD), flash memory, a Universal Serial Bus (USB) drive or a combination these or other storage devices.

As shown, the computing device 800 includes one or more I/O interfaces 808, which are provided to allow a user to provide input to (such as user strokes), receive output from, and otherwise transfer data to and from the computing device 800. These I/O interfaces 808 may include a mouse, keypad or a keyboard, a touch screen, camera, optical scanner, network interface, modem, other known I/O devices or a combination of such I/O interfaces 808. The touch screen may be activated with a stylus or a finger.

The I/O interfaces 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 808 are configured to provide graphical data to a display for presentation to a user. The graphical data may be representative of one or more graphical user interfaces and/or any other graphical content as may serve a particular implementation.

The computing device 800 can further include a communication interface 810. The communication interface 810 can include hardware, software, or both. The communication interface 810 provides one or more interfaces for communication (such as, for example, packet-based communication) between the computing device and one or more other computing devices or one or more networks. As an example, and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI. The computing device 800 can further include a bus 812. The bus 812 can include hardware, software, or both that connects components of computing device 800 to each other.

FIG. 9 illustrates an example network environment 900 of the inter-network facilitation system 604. The network environment 900 includes client device(s) 904 (e.g., client device(s) 608), an inter-network facilitation system 604, and third-party system(s) 906 connected to each other by network(s) 902. Although FIG. 9 illustrates a particular arrangement of the client device(s) 904, the inter-network facilitation system 604, the third-party system(s) 906, and the network(s) 902, this disclosure contemplates any suitable arrangement of the client device(s) 904, the inter-network facilitation system 604, the third-party system(s) 906, and the network(s) 902. As an example, and not by way of limitation, two or more of the client device(s) 904, the inter-network facilitation system 604, and the third-party system(s) 906 communicate directly, bypassing the network(s) 902. As another example, two or more of the client device(s) 904, the inter-network facilitation system 604, and the third-party system(s) 906 may be physically or logically co-located with each other in whole or in part.

Moreover, although FIG. 9 illustrates a particular number of the client device(s) 904, the inter-network facilitation system 604, the third-party system(s) 906, and the network(s) 902, this disclosure contemplates any suitable number of the client device(s) 904, inter-network facilitations systems, the third-party system(s) 906, and the network(s) 902. As an example, and not by way of limitation, network environment 900 may include multiple client devices, inter-network facilitation systems, third-party systems, and/or networks.

This disclosure contemplates any suitable network for the network(s) 902. As an example, and not by way of limitation, one or more portions of the network(s) 902 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. The network(s) 902 may include one or more networks.

Links may connect the client device(s) 904, inter-network facilitation system 604 (e.g., which hosts the data experiment configuration system 100), and the third-party system(s) 906 to the network(s) 902 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 900. One or more first links may differ in one or more respects from one or more second links.

In particular embodiments, the client device(s) 904 may be an electronic device including hardware, software, or embedded logic components or a combination of two or more such components and capable of carrying out the appropriate functionalities implemented or supported by the client device(s) 904. As an example, and not by way of limitation, the client device(s) 904 may include any of the computing devices discussed above in relation to FIG. 8. The client device(s) 904 may enable a network user at the client device(s) 904 to access the network(s) 902. The client device(s) 904 may enable its user to communicate with other users at other client devices of the client device(s) 904.

In particular embodiments, the client device(s) 904 may include a requester application or a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client device(s) 904 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device(s) 904 one or more Hyper Text Markup Language (“HTML”) files responsive to the HTTP request. The client device(s) 904 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 604 may be a network-addressable computing system that can interface between two or more computing networks or servers associated with different entities such as financial institutions (e.g., banks, credit processing systems, ATM systems, or others). In particular, the inter-network facilitation system 604 can send and receive network communications (e.g., via the network(s) 902) to link the third-party system(s) 906. For example, the inter-network facilitation system 604 may receive authentication credentials from a user to link the third-party system(s) 906 such as an online bank account, credit account, debit account, or other financial account to a user account within the inter-network facilitation system 604. The inter-network facilitation system 604 can subsequently communicate with the third-party system(s) 906 to detect or identify balances, transactions, withdrawal, transfers, deposits, credits, debits, or other transaction types associated with the third-party system(s) 906. The inter-network facilitation system 604 can further provide the aforementioned or other financial information associated with the third-party system(s) 906 for display via the client device(s) 904. In some cases, the inter-network facilitation system 604 links more than one of the third-party system(s) 906, receiving account information for accounts associated with each respective third-party system of the third-party system(s) 906 and performing operations or transactions between the different systems via authorized network connections.

In particular embodiments, the inter-network facilitation system 604 may interface between an online banking system and a credit processing system via the network(s) 902. For example, the inter-network facilitation system 604 can provide access to a bank account of the third-party system(s) 906 and linked to a user account within the inter-network facilitation system 604. Indeed, the inter-network facilitation system 604 can facilitate access to, and transactions to and from, the bank account of the third-party system(s) 906 via a client application of the inter-network facilitation system 604 on the client device(s) 904. The inter-network facilitation system 604 can also communicate with a credit processing system, an ATM system, and/or other financial systems (e.g., via the network(s) 902) to authorize and process credit charges to a credit account, perform ATM transactions, perform transfers (or other transactions) across accounts of different third-party systems of the third-party system(s) 906, and to present corresponding information via the client device(s) 904.

In particular embodiments, the inter-network facilitation system 604 includes a model for approving or denying transactions. For example, the inter-network facilitation system 604 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 604 and/or the third-party system(s) 906), the inter-network facilitation system 604 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 604 may be accessed by the other components of network environment 900 either directly or via the network(s) 902. In particular embodiments, the inter-network facilitation system 604 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by the server. In particular embodiments, the inter-network facilitation system 604 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable the client device(s) 904, or an inter-network facilitation system 604 to manage, retrieve, modify, add, or delete, the information stored in a data store.

In particular embodiments, the inter-network facilitation system 604 may provide users with the ability to take actions on various types of items or objects, supported by the inter-network facilitation system 604. As an example, and not by way of limitation, the items and objects may include financial institution networks for banking, credit processing, or other transactions, to which users of the inter-network facilitation system 604 may belong, computer-based applications that a user may use, transactions, interactions that a user may perform, or other suitable items or objects. A user may interact with anything that is capable of being represented in the inter-network facilitation system 604 or by an external system of a third-party system, which is separate from inter-network facilitation system 604 and coupled to the inter-network facilitation system 604 via the network(s) 902.

In particular embodiments, the inter-network facilitation system 604 may be capable of linking a variety of entities. As an example, and not by way of limitation, the inter-network facilitation system 604 may enable users to interact with each other or other entities, or to allow users to interact with these entities through an application programming interfaces (“API”) or other communication channels.

In particular embodiments, the inter-network facilitation system 604 may include a variety of servers, sub-systems, programs, modules, logs, and data stores. In particular embodiments, the inter-network facilitation system 604 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 604 may also include suitable components such as network interfaces, security mechanisms, load balancers, failover servers, management-and-network-operations consoles, other suitable components, or any suitable combination thereof. In particular embodiments, the inter-network facilitation system 604 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 604 and the client device(s) 904. An action logger may be used to receive communications from a web server about a user's actions on or off the inter-network facilitation system 604. In conjunction with the action log, a third-party-content-object log may be maintained of user exposures to third-party-content objects. A notification controller may provide information regarding content objects to the client device(s) 904. Information may be pushed to the client device(s) 904 as notifications, or information may be pulled from the client device(s) 904 responsive to a request received from the client device(s) 904. Authorization servers may be used to enforce one or more privacy settings of the users of the inter-network facilitation system 604. A privacy setting of a user determines how particular information associated with a user can be shared. The authorization server may allow users to opt in to or opt out of having their actions logged by the inter-network facilitation system 604 or shared with other systems, such as, for example, by setting appropriate privacy settings. Third-party-content-object stores may be used to store content objects received from third parties. Location stores may be used for storing location information received from the client device(s) 904 associated with users.

In addition, the third-party system(s) 906 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 604 via the network(s) 902. The third-party system(s) 906 can communicate with the inter-network facilitation system 604 to provide financial information pertaining to balances, transactions, and other information, whereupon the inter-network facilitation system 604 can provide corresponding information for display via the client device(s) 904. In particular embodiments, the third-party system(s) 906 communicates with the inter-network facilitation system 604 to update account balances, transaction histories, credit usage, and other internal information of the inter-network facilitation system 604 and/or the third-party system(s) 906 based on user interaction with the inter-network facilitation system 604 (e.g., via the client device(s) 904). Indeed, the inter-network facilitation system 604 can synchronize information across one or more of the third-party system(s) 906 to reflect accurate account information (e.g., balances, transactions, etc.) across one or more networked systems, including instances where a transaction (e.g., a transfer) from one of the third-party system(s) 906 affects another of the third-party system(s) 906.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
providing, by at least one processor and for display on a graphical user interface, selectable options comprising a plurality of experiment parameters for performing a data experiment;
generating, by the at least one processor in response to a set of selected options from the selectable options, a database management query comprising selected experiment parameters from a plurality of experiment metrics and a plurality of segments;
generating, by the at least one processor, baseline metrics defining statistical values for the data experiment by executing the database management query on a historical dataset stored at a database according to the selected experiment parameters;
providing, by the at least one processor and for display within the graphical user interface, a set of target metrics for performing the data experiment utilizing a set of variables and the baseline metrics; and
generating, by the at least one processor and for display within a calculator interface, data analysis results comprising a calculated value for a selected target metric of the set of target metrics by executing the data experiment utilizing the baseline metrics and selected variables from the set of variables.

2. The computer-implemented method of claim 1, further comprising determining, in response to one or more interactions with the selectable options in the graphical user interface, the plurality of experiment parameters comprising one or more of:
a statistical analysis type parameter from a predefined list of statistical analysis types;
a metric type parameter from a predefined list of metric types;
an intended population parameter from a predefined list of intended populations; or
a historical date range parameter from a set of historical date ranges of historical data in the database.

3. The computer-implemented method of claim 2, wherein determining the plurality of experiment parameters comprises determining, in response to an interaction with a selectable option of the selectable options, the intended population parameter comprising a population type parameter or a population subset parameter.

4. The computer-implemented method of claim 1, wherein generating the baseline metrics comprises generating, based on the selected experiment parameters and the historical dataset, a metric mean value and a standard deviation value for the data experiment.

5. The computer-implemented method of claim 1, further comprising presenting, for display within the graphical user interface, the baseline metrics in one or more editable fields by auto-populating the one or more editable fields in response to generating the baseline metrics.

6. The computer-implemented method of claim 1, further comprising:
determining the selected target metric in response to an interaction with the set of target metrics via the graphical user interface;
providing, for display within the graphical user interface, a plurality of editable fields comprising the set of variables according to the selected target metric; and
providing, for display within the graphical user interface, an updated calculated value for the selected target metric in response to an interaction with an editable field of the plurality of editable fields modifying a variable of the set of variables.

7. The computer-implemented method of claim 1, wherein generating the data analysis results further comprises concurrently generating corresponding calculated values for the set of target metrics by executing the data experiment utilizing the baseline metrics and selected variables from the set of variables.

8. A non-transitory computer-readable medium storing instructions that, when executed by at least one processor, cause a computer system to:
provide, by at least one processor and for display on a graphical user interface, selectable options comprising a plurality of experiment parameters performing a data experiment;
generate, by the at least one processor in response to a set of selected options from the selectable options, a database management query comprising selected experiment parameters from a plurality of experiment metrics and a plurality of segments;
generate, by the at least one processor, baseline metrics defining statistical values for the data experiment by executing the database management query on a historical dataset stored at a database according to the selected experiment parameters;
provide, by the at least one processor and for display within the graphical user interface, a set of target metrics for performing the data experiment utilizing a set of variables and the baseline metrics; and
generate, by the at least one processor and for display within a calculator interface, data analysis results comprising a calculated value for a selected target metric of the set of target metrics by executing the data experiment utilizing the baseline metrics and selected variables from the set of variables.

9. The non-transitory computer-readable medium of claim 8, that, when executed by the at least one processor, cause the computer system to determine, in response to one or more interactions with the selectable options in the graphical user interface, the plurality of experiment parameters comprising one or more of:
a statistical analysis type parameter from a predefined list of statistical analysis types;
a metric type parameter from a predefined list of metric types;
an intended population parameter from a predefined list of intended populations; or
a historical date range parameter from a set of historical data ranges of historical data in the database.

10. The non-transitory computer-readable medium of claim 9, that, when executed by the at least one processor, cause the computer system to determine the plurality of experiment parameters by determining, in response to an interaction with a selectable option of the selectable options, the intended population parameter comprising a population type parameter or a population subset parameter.

11. The non-transitory computer-readable medium of claim 8, that, when executed by the at least one processor, cause the computer system to generate the baseline metrics by generating, based on the selected experiment parameters and the historical dataset, a metric mean value and a standard deviation value for the data experiment.

12. The non-transitory computer-readable medium of claim 8, that, when executed by the at least one processor, cause the computer system to present, for display within the graphical user interface, the baseline metrics in one or more editable fields by auto-populating the one or more editable fields in response to generating the baseline metrics.

13. The non-transitory computer-readable medium of claim 8, that, when executed by the at least one processor, cause the computer system to:
determine the selected target metric in response to an interaction with the set of target metrics via the graphical user interface;
provide, for display within the graphical user interface, a plurality of editable fields comprising the set of variables according to the selected target metric; and
provide, for display within the graphical user interface, an updated calculated value for the selected target metric in response to an interaction with an editable field of the plurality of editable fields modifying a variable of the set of variables.

14. The non-transitory computer-readable medium of claim 8, that, when executed by the at least one processor, further comprises causing the computer system to generate the data analysis results by concurrently generating corresponding calculated values for the set of target metrics by executing the data experiment utilizing the baseline metrics and selected variables from the set of variables.

15. A system comprising:
at least one processor; and
at least one non-transitory computer-readable storage medium storing instructions that, when executed by the at least one processor, cause the system to:
provide, by at least one processor and for display on a graphical user interface, selectable options comprising a plurality of experiment parameters performing a data experiment;
generate, by the at least one processor in response to a set of selected options from the selectable options, a database management query comprising selected experiment parameters from a plurality of experiment metrics and a plurality of segments;
generate, by the at least one processor, baseline metrics defining statistical values for the data experiment by executing the database management query on a historical dataset stored at a database according to the selected experiment parameters;
provide, by the at least one processor and for display within the graphical user interface, a set of target metrics for performing the data experiment utilizing a set of variables and the baseline metrics; and
generate, by the at least one processor and for display within a calculator interface, data analysis results comprising a calculated value for a selected target metric of the set of target metrics by executing the data experiment utilizing the baseline metrics and selected variables from the set of variables.

16. The system of claim 15, that when executed by the at least one processor, cause the system to determine, in response to one or more interaction with the selectable options in the graphical user interface, the plurality of experiment parameters comprising one or more of:
a statistical analysis type parameter from a predefined list of statistical analysis types;
a metric type parameter from a predefined list of metric types;
an intended population parameter from a predefined list of intended populations; or
a historical date range parameter from a set of historical date ranges of historical data in the database.

17. The system of claim 16, that when executed by the at least one processor, cause the system to determine the plurality of experiment parameters by determining, in response to an interaction with a selectable option of the selectable options, the intended population parameter comprising a population type parameter or a population subset parameter.

18. The system of claim 15, that when executed by the at least one processor, cause the system to generate the baseline metrics by generating, based on the selected experiment parameters and the historical dataset, a metric mean value and a standard deviation value for the data experiment.

19. The system of claim 15, that when executed by the at least one processor, cause the system to present, for display within the graphical user interface, the baseline metrics in one or more editable fields by auto-populating the one or more editable fields in response to generating the baseline metrics.

20. The system of claim 15, that when executed by the at least one processor, cause the system to:
determine the selected target metric in response to an interaction with the set of target metrics via the graphical user interface;
provide, for display within the graphical user interface, a plurality of editable fields comprising the set of variables according to the selected target metric;
modify a variable of the set of variables in response to an interaction with an editable field corresponding to the variable within the graphical user interface; and
update the calculated value for the selected target metric and the set of variables based on the modified variable.
